(19) United States
(12) Patent Application Publication
(10) Pub. No.: US 2007/0008676 A1
(43) Pub. Date: Jan. 11, 2007

(54) Capacitor module

(76) Inventors: Hubertus Goesmann, Auernheim (DE); Hartmut Michel, Heidenheim (DE); Stefan Nowak, Heubach (DE); Michael Setz, Beimerstetten (DE); Annemarie Setz, Beimerstetten (DE); Bernd Staib, Syrgenstein (DE)

Correspondence Address: FISH & RICHARDSON PC, P.O. BOX 1022, MINNEAPOLIS, MN, 55440-1022, US

(21) Appl. No.: 11/352,453

(22) Filed: Feb. 10, 2006

(30) Foreign Application Priority Data
Aug. 9, 2004 (WO) PCT/DE04/01785
Aug. 12, 2003 (DE) 10337041.2

(51) Int. Cl. H01G 4/38

(52) U.S. Cl. 361/328

(57) ABSTRACT

A capacitor module includes a first capacitor and a second capacitor, the first capacitor and the second capacitor each including a first electric terminal and a second electric terminal, a conductor to connect corresponding first electric terminals of the first capacitor and the second capacitor, and a connector to connect the conductor to corresponding second electric terminals of the first capacitor and the second capacitor.

### CROSS REFERENCE TO RELATED APPLICATIONS

This application is a continuation of, and hereby claims priority to, International Application No. PCT/DE2004/001785, which claims priority to German Patent Application No. 10337041.2. The contents of International Application No. PCT/DE2004/001785 and German Patent Application No. 10337041.2 are hereby incorporated by reference into this application as if set forth here in full.

### BACKGROUND

In capacitors, e.g., double-layer capacitors, the cell voltage is usually limited to a few volts. For many applications, however, much higher operating voltages are needed, so multiple capacitors are connected in series to form a capacitor module. With capacitor modules, the individual capacitors are often connected to other capacitors via terminal plates. Individual capacitors often have varying spontaneous discharge behavior, so the total voltage is often not distributed uniformly among the individual capacitors. Therefore, overvoltages may occur on individual capacitors, leading to rapid aging or even destruction of the capacitor. For this reason, voltage balancing is often performed on electric terminals by complex measures to achieve a controlled spontaneous discharge. To this end, high-resistance electric connections are often provided between the two electric terminals of a capacitor. The capacitors are often provided with solderable hard-wired resistors or with printed circuit board assemblies on which resistors are present. The hard-wired resistors may be connected to the electric terminals by riveted solder lugs.

### SUMMARY

In one aspect, the application is directed to a capacitor module that includes a first capacitor and a second capacitor, each comprising a first electric terminal and a second electric terminal, a conductor to connect together corresponding ones of the first electric terminals of the first capacitor and the second capacitor, and a connector to connect the conductor with the corresponding ones of the second electric terminals of the first capacitor and the second capacitor.

Implementations may include one or more of the following features. The conductor can be a flat conductor. The first and second electric terminals can be first and second external electric terminals. The connector can comprise a wire, and the wire can be an aluminum wire, where the aluminum wire has a thickness of two millimeters. There can be electric components implemented on the conductor. A connection plate can connect together the corresponding ones of the second electric terminals of the first and second capacitors such that the connection plate is in contact with the conductor. The conductor can comprise at least one of a nickel-plated terminal plate or a tin-plated terminal plate. There can also be a connecting plate to connect a third capacitor with at least one of the corresponding ones of the first electric terminals of the first and second capacitors. Any of the connecting plate, connector or the conductor can be laser weldable. The conductor can also be a plastic board.

The capacitor module has at least a first and a second capacitor, each capacitor having a first external electric terminal and a second external electric terminal. The first electric terminals of the two capacitors are electrically connected by a flat conductor. The flat conductor and the two second electric terminals are electrically connected.

The capacitor module has a circuit board which is electrically connected to the first electric terminals as well as to the second electric terminals of each of the two capacitors. Thus, voltage balancing of the two capacitors can be achieved through a common circuit. In contrast, traditional voltage balancing of two capacitors is performed by independent circuits for each capacitor. Therefore, there are fewer components in which a defect could result in an impairment of the capacitor module.

In addition, the capacitor has a laser weldable wire, which is an additional electric connection between the conductor and the second electric terminals of the first and second capacitors. The wire can be an aluminum wire approximately 2 mm thick.

The flat conductor has electric components that establish a high-resistance electric connection. The electric components include electric resistors. The electric resistors allow a high-resistance electric connection such as that required for voltage balancing.

The electric resistors are implemented on the flat conductor. The flat conductor may include an epoxy resin board, for example, in which copper conductors are provided for electric contacting of the electric terminals of the capacitors and the electric components.

The second electric terminals of each of the two capacitors are electrically connected with each other via a first connecting plate. The first connecting plate is in electrical contact with the flat conductor.

The first connecting plate can be an internal series connection between individual capacitors in the capacitor module. The first connecting plate establishes contact between the two second electric terminals of the two capacitors and the flat conductor, e.g., via a wire.

The flat conductor is in electric contact with the first electric terminals over laser weldable connections. The laser weldable connections can be, for example, nickel-plated or tin-plated terminal plates which are implemented on the flat conductor. The terminal plates can then be connected to the first electric terminals by laser spot welds. The laser welding results in a bonded electrically conducting connection. In the bonded connection, the materials of the terminal plates and the first electric terminals, e.g., aluminum in both cases, are directly connected to one another. At least one of the first electric terminals or one of the two capacitors may be electrically connected to a third capacitor in the capacitor module via a second connecting plate.

In addition to the two capacitors already present, additional capacitors can be connected in series in the capacitor module via the second connecting plate.

The contact areas between the first electric terminals and the second connecting plate can be laser weldable. During laser welding, the metal of the first electric terminals, which can be aluminum, is bonded to the material of the second connecting plate, which likewise can be aluminum, resulting in an electrical connection.

The flat conductor may include a plastic board. Plastic boards can be manufactured easily and inexpensively, and electrically conducting conductors, e.g., in the form of copper conductors can be implemented on these plastic boards and can be used for electric connection of the resistors by the surface mount device (SMD) technique.

In another aspect, the application is directed to a method of manufacturing a capacitor module comprised of a plurality of capacitors, each comprising a first and second electric terminal. The method includes using a conductor to connect together the corresponding ones of the first electric terminals of the plurality of capacitors, where connecting together comprises welding, and connecting the conductor with corresponding ones of the second electric terminals of the plurality of capacitors.

Implementations may include one or more of the following features. The method can further comprise implementing at least one electric component on the conductor, and the electric component can comprise a resistor. In the method, connecting the conductor can comprise using a wire that is electrically conductive. The method can also comprise implementing at least one of a tin-plated terminal plate or a nickel-plated terminal plate on the conductor, and the terminal plate can connect the wire to the conductor.

The method allows for balancing of two electric capacitors in a capacitor module. The welding of the electric connections results in balancing of voltages of the two capacitors in the capacitor module. Resistors are premounted on the flat conductor to produce a high-resistance electric connection. More specifically, the resistors are implemented on premounted circuit boards, as opposed to individually connected to the capacitor terminals.

Tin-plated or nickel-plated connecting plates are laser weldable and are contacts to the first electric terminals on the conductor. During laser welding, the nickel or tin layer evaporates and allows a bonded connection to be formed between the metal (e.g., Al) of the first electric terminals and the metal of the terminal plates, which can also be aluminum.

The conductor can be electrically connected with an electrically conducting wire, e.g., an aluminum wire to the two second electric terminals. The wire can be in electric contact with the flat conductor through another tin-plated or nickel-plated terminal plate.

The wire can be inserted through a terminal hole and into the additional tin-plated or nickel-plated terminal plate, and then a permanent connection can be established by laser welding.

Tin-plated or nickel-plated terminal plates are implemented on the flat conductor for contacting the first electric terminals of the capacitors and also for contacting the wire for the second electric terminals. The contact areas between the first electric terminals and the second connecting plate can be tin-plated or nickel-plated. This second connecting plate can establish a series connection of other capacitors in the capacitor module.

In this method, the laser welding step comprises welding both the first electric terminals of the two capacitors to the second connecting plate, welding the tin-plated or nickel-plated terminal plates between the first terminals and the flat conductor and welding the connection between the flat conductor and the wire for connection to the second electric terminals.

In this aspect of the method, the contacts for voltage balancing (contacts between the first electric terminals and the flat conductor, contacts between the flat conductor and the wire for contacting the second electric terminals) as well as the contacts for the series connection of multiple capacitors in the capacitor module (contacts between the first electrically conducting terminals and the second connecting plate) can be welded.

### BRIEF DESCRIPTION OF THE DRAWINGS

FIG. 1 shows a perspective view of a capacitor module.

FIG. 2 shows a perspective view of a capacitor module.

FIG. 3 shows an overhead view of a capacitor module.

### DETAILED DESCRIPTION

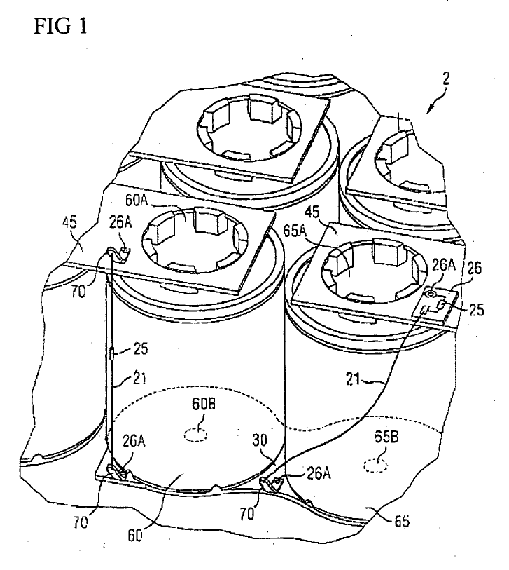

FIG. 1 shows a capacitor module 2 in which a first capacitor 60 and a second capacitor 65 are shown in the foreground. Additional capacitors may be connected in series via the first electric terminals 60A and 65A of these two capacitors. In addition, there is also a second terminal plate 30, shown with dotted lines, that electrically connects the second electrical terminal 60B and 65B present at the bottom of the two capacitors. The two capacitors 60 and 65 are voltage balanced separately from one another.

In the first capacitor 60, an electrically conducting hard-wired resistor 25 is established between the first electric terminal 60A and the second electric terminal 60B. In doing so, the wire 21 of the electric resistor 25 is connected to the first electric terminal 60A and also to the second electric terminal 60B via solder lugs 70. The two solder lugs 70 of the first and second electric terminals are connected by rivets 26A to the second terminal plate 30 and/or the first terminal plate 45. Thus, soldering steps are performed to connect wire 21 to solder lugs 70. The solder lugs are attached separately by rivets 26A to the particular plates.

The second capacitor 65 is voltage balanced with a resistor which establishes a high-resistance electric connection between the first terminal 65A and the second terminal 65B. A circuit board 26 or an electric resistor 25 is used in this process. This electric resistor is attached to the electric terminal plate 45 by means of a rivet 26A. In addition, there is also a wire 21 which electrically connects a solder lug 70 on the second terminal plate 30 to the circuit board 26A and the resistor 25. There are also several soldering steps (connecting the wire 21 to solder lugs 70 and to circuit board 26) and riveting steps (attaching the circuit board 26 to the second terminal plate 45 and attaching the solder lug to the first terminal plate 30).

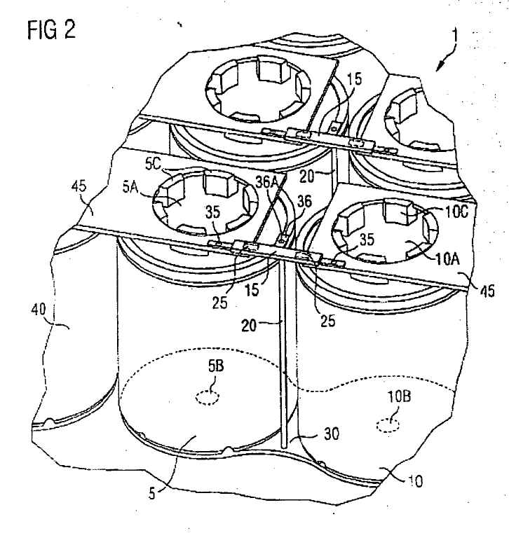

FIG. 2 shows a perspective view of a capacitor module, showing a first capacitor 5 and a second capacitor 10 in the foreground, each having a first electric terminal 5A, 10A and a second electric terminal 5B, 10B on the bottom of the respective capacitor. In addition, a flat conductor 15 is also provided, e.g., in the form of an epoxy resin board on which electric printed conductors, e.g., copper conductors are implemented. This conductor 15 also has electric components in the form of resistors 25, shown with dotted lines in FIG. 2, on the bottom side. The flat conductor 15 is connected to the first terminals 5A, 10A via two terminal plates 35, which can be tin-plated or nickel-plated, via second connecting plates 45. These second connecting plates 45 contact the first electric terminals 5A and 10A of the two capacitors and permit a series connection with other capacitors, e.g., capacitors 40 in the capacitor module. Since the second connecting plates 45 are also electrically connected to the first electric terminals 5A and 10A, an electric connection of the conductor 15 to the first electric terminals is thus established via the terminal plates 35. In addition, another terminal plate 36 is also provided, having a hole 36A for connecting the wire 20. This wire 20 is electrically connected to the second electric terminals 5B and 10B via the first terminal plate 30.

The laser weldable tin-plated or nickel-plated terminal plates 35 or 36 establish a connection between the flat conductor 15 and the first electric terminals 5A and 10A. The terminal plate 36 and the wire 20 are also welded together. In addition, the terminal segments SC, 10C can be laser-welded to the connecting plates 45. Thus, two capacitors 5 and 10 can be voltage balanced by a common circuit and joined together.

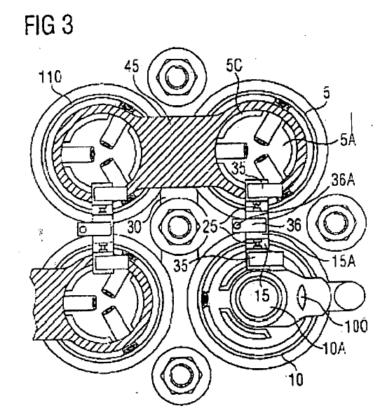

FIG. 3 shows a top view of a capacitor module. A first capacitor 5 and a second capacitor 10 are shown in the right area of FIG. 3; these two capacitors have been voltage balanced via a flat conductor 15. The flat conductor 15, a circuit board here, is electrically connected via terminal plates 35 to the particular first electric terminals 5A and 10A. The first capacitor 5 is an electrically conducting connection between the circuit board 15 and a second connecting plate 45 which is in electric contact with the first electric terminal 5A. The second connecting plate 45 establishes a series connection of the capacitor 5 with a third capacitor 10.

Two SMD type resistors 25 are implemented on the circuit board. The circuit board 15 includes an epoxy resin board or a hard paperboard on which copper conductors 15A are implemented, to ensure an electric connection of resistors 25 to the first electric terminals SA and 10A. In addition, another terminal plate 36 having a hole 36A in which a wire is situated (not shown in FIG. 3) is also provided on the circuit board 15. This wire provides a connection to a first connecting plate 30 which connects the second electric terminals (also not shown in FIG. 3) of the two capacitors 5 and 10 to one another. In addition, a screw connection 100 is implemented for a tight connection on the first electric terminal 10A of the capacitor 10.

Other implementations are also possible, in particular with regard to the contact between the flat conductor and the first electric terminals as well as the contact between the conductor and the second electric terminals.

What is claimed is:

1. A capacitor module comprising:
a first capacitor with a first and second electric terminal;
a second capacitor with a third and fourth electric terminal;
a conductor to connect together the first electric terminal and the third electric terminal; and
a connector to connect the conductor with the second electric terminal and the fourth electric terminal.

2. The capacitor module of claim 1, wherein the conductor comprises a flat conductor.

3. The capacitor module of claim 1, wherein at least one of the first electric terminal, the second electric terminal, the third electric terminal, and the fourth electric terminal comprises an external electric terminal.

4. The capacitor module of claim 1, wherein the connector comprises a wire.

5. The capacitor module of claim 1, wherein the connector is laser weldable.

6. The capacitor module of claim 4, wherein the wire comprises an aluminum wire.

7. The capacitor module of claim 6, wherein the aluminum wire has a thickness of two millimeters.

8. The capacitor module of claim 1, further comprising one or more electric components on the conductor.

9. The capacitor module of claim 1, further comprising a connection plate to connect the second electric terminal and fourth electric terminal, wherein the connection plate is in contact with the conductor.

10. The capacitor module of claim 1, wherein the conductor is laser weldable.

11. The capacitor module of claim 1, wherein the conductor comprises at least one of a nickel-plated terminal plate and a tin-plated terminal plate.

12. The capacitor module of claim 1, further comprising a connecting plate to connect a third capacitor with at least one of the first electric terminal or the third electric terminal.

13. The capacitor module of claim 12, wherein the connecting plate is laser weldable.

14. The capacitor module of claim 1, wherein the conductor comprises a plastic board.

15. A method for manufacturing a capacitor module comprised of a plurality of capacitors, each capacitor comprising a first electric terminal and a second electric terminal, the method comprising:
using a conductor to connect corresponding first electric terminals of the plurality of capacitors, wherein connecting comprises welding; and
connecting the conductor to corresponding second electric terminals of the plurality of capacitors.

16. The method of claim 15, further comprising implementing at least one electric component on the conductor.

17. The method of claim 16, wherein the at least one electric component comprises a resistor.

18. The method of claim 15, further comprising at least one of a tin-plated terminal plate and a nickel-plated terminal plate on the conductor.

19. The method of claim 15, wherein connecting the conductor comprises using a wire that is electrically conductive.

20. The method of claim 19, further comprising using a tin-plated terminal plate or a nickel-plated terminal plate to connect the wire to the conductor.
